(19) United States
(12) Patent Application Publication
(10) Pub. No.: US 2008/0187723 A1
(43) Pub. Date: Aug. 7, 2008

(54) Coating Method And Decorative Panel Produced Using Said Method

(75) Inventors: Thierry Miclo, Schiltigheim (FR); Jean-Jacques Strub, Strasbourg (FR); Claude Campo, Strasbourg (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ESPACE PRODUCTION INTERNATIONAL EPI, Marlenheim (FR)

(21) Appl. No.: 11/912,547

(22) PCT Filed: Apr. 25, 2006
(86) PCT No.: PCT/FR06/50382

§ 371 Date: Oct. 25, 2007

(30) Foreign Application Priority Data
Apr. 25, 2005 (FR) 0551064
Jul. 12, 2005 (FR) 0552159

(51) Int. Cl. B32B 3/02; C09J 175/02; B29C 65/48

(52) U.S. Cl. 428/192; 156/331.7; 156/278

(57) ABSTRACT

The invention relates to a method for coating at least one upper face (3) and at least one contoured edge (5, 6) of a wooden, synthetic and/or composite decorative panel (1) with a decorative sheet (4). The inventive method is characterized in that it comprises the following steps consisting in: coating all or part of the upper face (3) with a urea-formaldehyde glue (C1); coating the contoured edge(s) (5, 6) with a different glue (C2), particularly of the polyurethane or polyvinyl-acetate type; and applying the decorative sheet (4) on the upper face (6) and the contoured edges (5, 6), for example by means of lamination. The invention also relates to the decorative panel thus produced.

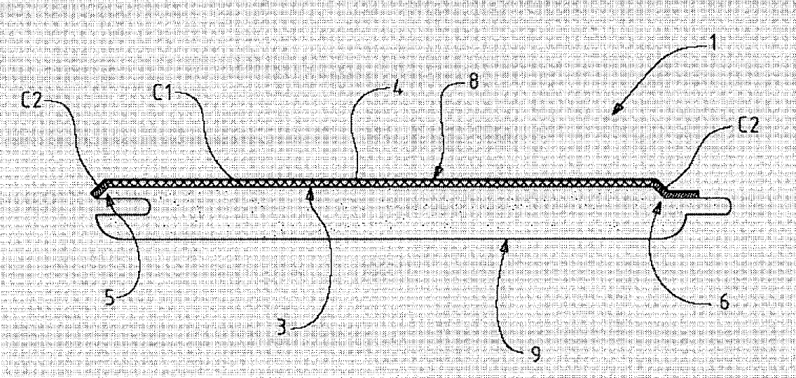

### BACKGROUND OF THE INVENTION

(1) Field of the Invention

The invention relates to a method for coating at least one upper face and at least one contoured edge of a wooden, synthetic or composite decorative panel with a decorative sheet.

The invention also relates to the panels produced using such a method.

The present invention relates to the field of the manufacture of decorative panels for floor, wall or ceiling covering.

(2) Description of the Prior Art

In particular, as decorative panel are known the floor coverings referred to as laminated coverings in the form of boards the edges of which are provided with encasing means of the tongue-and-groove type and which have been cut from melamine-coated large-size panels. On the latter has been applied, through hot pressing, on the upper face, a melamine-impregnated decorative sheet and an overlay and, on the lower face, a counterbalance, very often in the form of a cellulose sheet, such as kraft paper.

Such laminated floor coverings are particularly suitable for an edge-to-edge laying of boards, i.e. with gaps being as discrete as possible, but which therefore define weak points in terms of resistance to abrasion, punching and moisture. Therefore, a new style of laminated parquet floor has now taken a lead on the market, parquet floor made up of boards that, after assembling and laying, has visible seams. To this end, the edges of these boards are contoured, in other words machined, as the case may be in the form of a chamfering or the like. Thus, once the floor covering has been laid, a space in the form of a groove is clearly visible between the boards.

Obviously, the contouring or chamfering operation on laminated boards causes visible edges without coating showing the material the core of each of these boards is made of.

Therefore, an additional manufacture phase is required, during which each chamfer receives a coating, for example in the form of an impregnating resin, such as a varnish, providing it with a final aspect, as the case may be, in terms of colour, identical or close to that of the upper face of the board considered, or, to the contrary, perfectly distinctive, so as to reveal even more the groove between the assembled boards.

It is also known to coat the chamfers of these boards with a decorative film deposited from a transfer paper.

There is also known the coating technique consisting in applying, by means of glue, a layer of coating paper on a panel or a previously contoured board.

The implemented manufacturing method consists in cutting, from non-decorated large-size panels, boards the edges of which are contoured in order to form, after assembling, a floor or wall covering.

In particular, such boards can be provided, on the longitudinal and/or transverse edge, with encasing means of the groove-and-tongue type, as well as are capable of adopting, through machining, a specific contour with a round, chamfered shape or the like.

Through this coating technique, these contoured boards are coated, both on their visible upper face and at the level of their contoured edges, with a decorative paper providing them the desired decorative aspect.

For coating, hence for fixing the layer of decorative paper, one generally uses polyurethane or polyvinyl-acetate glue very easy to be implemented and permitting, as a matter of fact, coating the full surface of the board, including at the level of its contoured edge or edges.

Nevertheless, such adhesives do not allow obtaining at the level of these boards a decorative surface of an optimal hardness, abrasion resistance, impact strength and heat resistance.

One has already thought of using layers of decorative paper including a varnish impregnation improving this abrasion resistance substantially. It is even known to enhance this quality by subjecting the layer of varnish to an electron beam, which enhances its hardness.

The use of more technical, hence more expensive, adhesive leads to floor coverings of a cost price that is not competitive, for example, compared to laminated parquet floors.

It is within the framework of a first inventive step that one has thought of using glue of a lower cost price, but meeting however perfectly the specifications to be fulfilled by a decorative panel for floor or wall covering.

In fact, it has been known for a long time to use, in the field of plating: urea-formaldehyde or urea-resin glue, glue pertaining to the thermoforming family, which reacts under the action of a hardener.

Like with the melamine-coated panels, coating with urea-resin glue is implemented only on large-size panels. The manufacture of contoured boards from such panels gives rise to the same problems as within the framework of laminated boards, namely the coating of the contoured edges of the boards cut from these panels.

### SUMMARY OF THE INVENTION

Finally, the present invention pretends to be capable of coping with all the above-mentioned problems by implementing this solution of coating using urea-resin glue on the decorative upper face of the panels, this in combination with a coating with a different glue at the level of the contoured edges of such a panel, in particular of the polyurethane, polyvinyl-acetate type, etc.

Finally, the present invention could be brought about by departing from a prejudice with the specialist in the art consisting in that the technique of coating by means of urea-resin glue cannot be applied to contoured panels.

It should be noted that, in particular, thanks to the present invention a contoured panel can be achieved the decorative upper face of which has a perfect abrasion resistance compared to contoured panels coated according to the known techniques.

In a quite as particular way, this advantage results from the use of glue of a cost price allowing achieving floor, wall covering panels or the like of a very low manufacturing cost.

### BRIEF DESCRIPTION OF THE DRAWING

The invention will be better understood when reading the following description with reference to the attached drawing illustrating, schematically in one single figure, a decorative panel of the type wall or floor-covering board, on which a decorative sheet is applied by a method according to the invention.

### DETAILED DESCRIPTION OF THE PREFERRED EMBODIMENTS

In particular, this method according to the invention is a process for coating a decorative panel 1 including a core 2 which can contain wood, for example of MDF or HDF or particle wood, as well as being made out of composite or exclusively synthetic material. It should be noted that this core of the decorative panel 1 can be made out of recycled materials.

Such a decorative panel 1 also includes an upper face 3 coated with a decorative sheet 4, which in addition coats at least one of the contoured edges 5, 6 this panel 1 includes. Such a contouring can be in the form of roundness, a chamfering or the like. It should be noted that at the level of these edges 5, 6 of the panel 1 can be provided encasing means, of the groove-and-tongue type for assembling these panels for creating a floor, wall covering or the like.

According to the inventive method, coating a panel 1 with the decorative sheet 4 at the level of its upper face 3 and its contoured edge or edges 5, 6 consists in coating the full or part of the upper face 3 with urea-resin glue, while the contoured edge or edges 5, 6 are coated with a different glue, of the polyvinyl-acetate (or PVAC), polyurethane type or the like.

When it is mentioned that the upper face 3 is coated, fully or partly, with urea-resin glue, it should be understood that this coating with glue can occur on only part of the width of the upper face 3 of the panel 1, whereas close to the edges 5, 6 may be preferred an application of a different glue in order to facilitate their coating with the decorative sheet 4.

As a matter of fact, in another step of the method according to the invention, one proceeds to applying the decorative sheet 4, namely by calendering, on this upper face 3 of the panel 1 and on this or these contoured edges 5, 6.

It should be noted, in particular, that one can proceed in two different coating steps for the upper face 3 of the panel 1, on the one hand, and its contoured edge or edges 5, 6, on the other hand.

In this case, one first of all coats the full or part of the upper face 3 of the panel 1 with urea-resin glue C1 before applying to same, by calendering, the decorative sheet 4. Then, one proceeds to coating the edge or edges 5, 6 of the latter with a different glue C2, for example a polyurethane glue, before applying to this or these edges 5, 6 the decorative sheet 4.

The latter can receive, before or after coating, a layer of varnish on its visible face 8. Furthermore, for an application as floor covering, such a varnish is capable of being subjected to any kind of treatment, which would improve its abrasion resistance.

During either step of this coating method, the panel 1 can also be coated, on its lower face 9, with a layer of any coating. In particular, the latter can constitute a counterbalancing for the decorative coating on the upper face 3 and/or ensure an insulation function.

The advantages that derive from this invention consist in that on the main bearing surface of the decorative panel 1 can be applied glue that, although it is of a low cost price, contributes to obtaining high mechanical performances for such panels.

1. Method for coating at least one upper face and at least one contoured edge of a wooden, synthetic or composite decorative panel with a decorative sheet, wherein:
all or part of the upper face is coated with urea-resin glue;
the contoured edge or edges are coated with a different glue, in particular of the polyurethane, polyvinyl-acetate type;
the decorative sheet is applied, in particular by calendering, on the upper face (6) and the contoured edge or edges.

2. Coating method according to claim 1, wherein after coating with urea-resin glue and applying the decorative sheet on the upper face of the decorative panel, the contoured edge or edges are coated with glue and on the latter is applied said decorative sheet.

3. Process according to claim 1, wherein the upper face of the decorative panel is coated with a layer of a coating constituting a counterbalancing and/or an insulation.

4. Decorative panel including, at least its upper face and at least one contoured edge coated with a decorative sheet, wherein said decorative sheet is fixed by means of urea-resin glue on all or part of the upper face and by means of a different glue, in particular of the polyurethane or polyvinyl-acetate type, on the contoured edges.

5. Process according to claim 2, wherein the upper face of the decorative panel is coated with a layer of a coating constituting a counterbalancing and/or an insulation.
